(19) United States
(12) Patent Application Publication
(10) Pub. No.: US 2012/0135135 A1
(43) Pub. Date: May 31, 2012

(54) COATING APPARATUS AND COATING METHOD

(75) Inventors: Naoaki SAKURAI, Yokohama-shi (JP); Tsuyoshi Sato, Yokohama-shi (JP); Masakuni Ikagawa, Ebina-shi (JP)

(73) Assignee: KABUSHIKI KAISHA TOSHIBA, Tokyo (JP)

(21) Appl. No.: 13/365,973

(22) Filed: Feb. 3, 2012

Related U.S. Application Data
(62) Division of application No. 11/177,294, filed on Jul. 11, 2005, now abandoned.

(30) Foreign Application Priority Data
Jul. 12, 2004 (JP) 2004-204927

(51) Int. Cl. B05D 5/12

(52) U.S. Cl. 427/58

(57) ABSTRACT

In applying a coating liquid including a solute and a solvent onto a given area on a substrate so as to allow the coating liquid to be solidified on the substrate by volatizing the solvent, an atmosphere in a vicinity of a coated area of the substrate is kept under an atmosphere that reduces volatilization of the solvent until applying the coating liquid onto the given area of the substrate is finished.

### CROSS-REFERENCE TO RELATED APPLICATION

This application is a divisional of U.S. patent application Ser. No. 11/177,294, filed Jul. 11, 2005, the contents of which are incorporated herein by reference, and which claims the priority to Japanese Patent Application No. 2004-204927, filed Jul. 12, 2004.

### BACKGROUND OF THE INVENTION

1. Field of the Invention

The present invention relates to a coating apparatus and a coating method for use in manufacturing electronic devices such as a semiconductor device and a display device incorporating a liquid crystal panel or an organic EL (Electroluminescence) panel.

2. Description of the Related Art

In manufacturing such electronic devices a water solution or a coating liquid containing an inorganic or organic solvent is applied onto a substrate to form thereon a film such as a functional layer and a resist layer. Typical coating methods include a spin coating method, an ink jet method, and a slit coating method, and in particular, the ink jet method has been used in forming a film that needs fine patterning such as a light emitting layer and color filter layer of a display device.

Such a coating process has an issue that a coating liquid is solidified with an irregular surface shape because it is not homogeneously dried within a coated area on the substrate. For instance, an organic EL ink, ejected onto a glass substrate from a coater head of an ink jet coating apparatus, is inhomogeneously dried within a coated area on the glass substrate, and thereby the surface shape of the solidified organic EL ink become irregular. Since such irregularities, the drying irregularity of a coating liquid and the surface shape irregularity of the solidified coating liquid, adversely affect the manufacturing of electronic devices, these irregularities need to be suppressed as less as possible.

Japanese Patent Application Laid-open No. 2003-266003 discloses a method of manufacturing a functional element by drying a functional layer forming solution applied onto a substrate through the use of a coating method such as an ink jet method. To allow the surface shape of a functional layer formed in the above process to be flat, this related art proposes a drying method that controls the volatilizing speed of a solvent, depending on the surface shape of the functional layer.

However, this method intends to locally control the volatilizing speed of the solvent by focusing on the local surface shape of the functional layer formed on the substrate, and therefore it has not always been easy to prevent the drying irregularity of the functional layer forming solution and the surface shape irregularity of the solidified functional layer forming solution throughout the total coated area on the substrate.

### SUMMARY OF THE INVENTION

The present invention has been completed with the above issue in mind and has a purpose to provide a coating apparatus and a coating method that make it possible to homogeneously dry a coating liquid applied to a substrate throughout the total coated area thereof as well as to uniform the surface shape of the solidified coating liquid.

A first aspect of the present invention provides a coating apparatus comprising a coater applying a coating liquid including a solute and a solvent onto a given area on a substrate, and an atmosphere holder keeping an atmosphere in a vicinity of a coated area on the substrate under an atmosphere that reduces volatilization of the solvent until applying the coating liquid to the given area of the substrate is finished.

A second aspect of the present invention provides a coating method for applying a coating liquid including a solute and a solvent onto a given area on a substrate so as to allow the coating liquid to be solidified on the substrate by volatizing the solvent, wherein an atmosphere in a vicinity of a coated area on the substrate is kept under an atmosphere that reduces volatilization of the solvent until applying of the coating liquid onto the given area of the substrate is finished.

### BRIEF DESCRIPTION OF THE DRAWINGS

FIG. 1 is a perspective view showing the overall structure of a coating apparatus according to the first embodiment of the present invention.

FIG. 2 is a perspective view showing a concrete structure of a coater forming the coating apparatus shown in FIG. 1.

FIGS. 3A to 3F are typical views illustrating an evaporation mechanism of a coating liquid coated on a substrate.

FIG. 4 is a perspective view showing the overall structure of a coating apparatus according to the second embodiment of the present invention.

FIG. 5 is a perspective view showing the overall structure of a coating apparatus according to the third embodiment of the present invention.

FIG. 6 is a view illustrating an essential section of FIG. 5.

FIG. 7 is a table showing experimental results, conducted as an example of the present invention, under a condition where an atmosphere in a vicinity of a coated area on a substrate is maintained under an atmosphere containing a different solvent from a solvent contained in the coating liquid.

FIG. 8 is a graph showing a relationship between a residue weight ratio and a time period in which a substrate is left in a coater, in the table shown in FIG. 7.

### DETAILED DESCRIPTION OF THE PREFERRED EMBODIMENTS

Embodiments according to the present invention are described below with reference to the accompanying drawings.

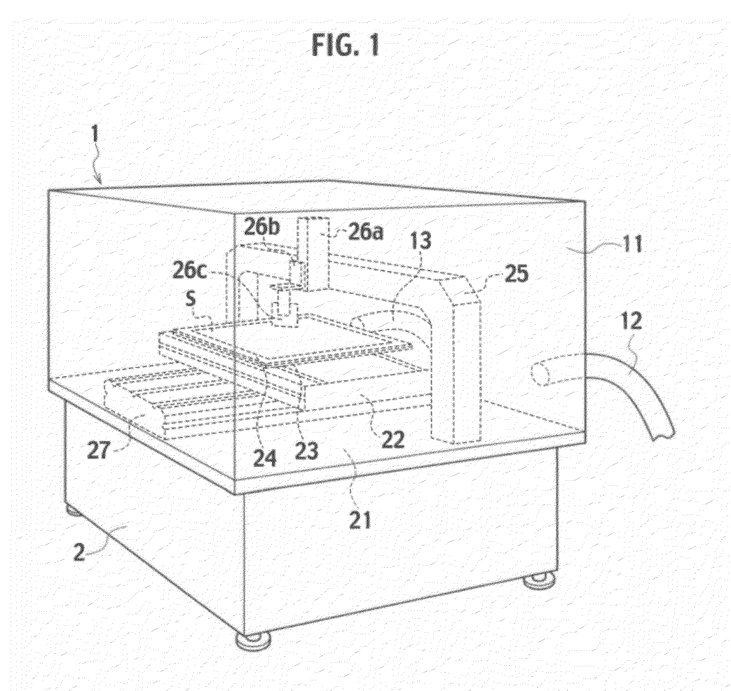

FIG. 1 is a perspective view showing the overall structure of an ink jet coating apparatus 1 forming a coating apparatus according to the first embodiment of the present invention. The ink jet coating apparatus 1 comprises an ink coater box 11 that plays a role as an atmosphere holder for covering a coater provided on a top surface portion 21 of a base 2. The ink coater box 11 includes a supply pipe 12 leading a gas delivered from a gas supply source (not shown) to the ink coater box 11, and an exhaust pipe 13 connected to an exhaust device (not shown) to permit a gas to be exhausted from the inside of the ink coater box 11. Further, gas concentration detectors are located at given positions in the ink coater box 11 for detecting gas and moisture concentrations in the ink coater box 11. Feature quantities of a gas to be supplied to the ink coater box 11 (such as a kind, concentration or humidity, and flow rate) can be altered or regulated, and then these quantities are controlled such that an atmosphere inside the ink coater box 11 is sustained in an atmosphere that inhibits volatilization of a solvent.

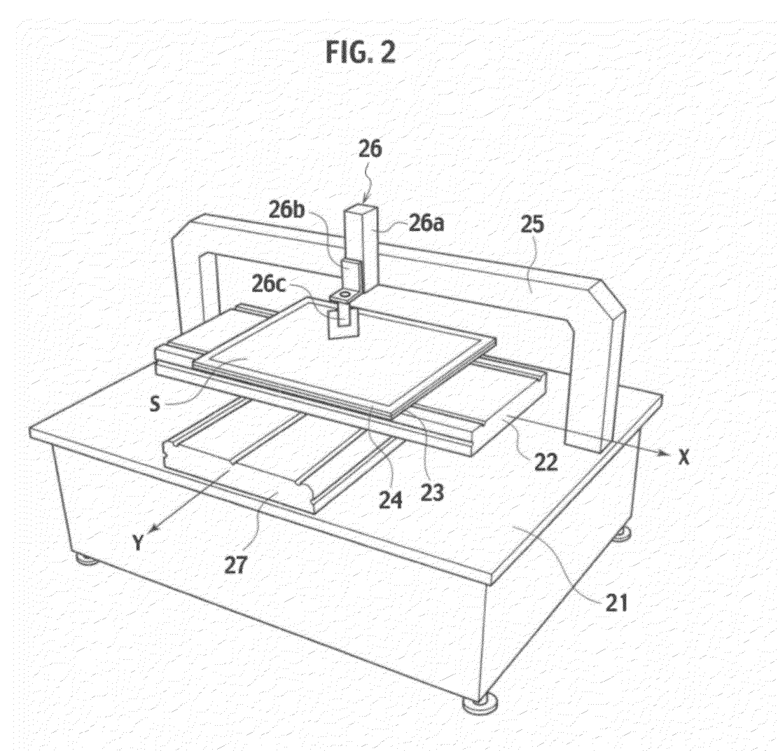

FIG. 2 is a perspective view showing a concrete structure of the ink coater box 11. Sequentially mounted on the top surface portion 21 of the base 2 are a stage 24, a support table 23 by which the stage 24 is supported, an X-table 22 moving the support table 23 in an X-direction in this figure, and a Y-table moving on the X-table in a Y-direction in this figure. The stage 24 has a top surface potion on which is retained a substrate S such as a glass substrate for an organic EL panel. Of course, the substrate S is not limited to such a glass substrate.

Further, on the top surface portion 21 of the base 2 an arch-shaped support body 25 carrying a coater head unit 26 stands upright in a way to straddle the stage 24. The coater head unit 26 includes an elevator member 26a mounted on the arch-shaped support body 25 and being movable in a vertical direction, an L-shaped support segment 26b mounted on a side face of the elevator member 26a, and a coater head 26c mounted on a horizontal portion of the L-shaped support segment 26b in a way oriented downward and having a vertically extending rotary shaft to allow the coater head 26c to be rotatable.

With the coater shown in FIG. 2, a coating liquid (an ink) is applied onto a given area on the substrate S in the following manner: first, the ink is supplied from an ink supply tank (not shown) to the coater head 26c disposed in a way to be close to the substrate S retained on the stage 24. Next, during a time period in which droplets of the ink are ejected from the coater head 26c toward the substrate S, the substrate S is moved by the X-table 22 and the Y-table 27.

Then, the related art set forth above has possibilities that the coated ink is dried on the substrate S with an irregular surface shape. This is probably caused by the fact that in general atmosphere and airflow conditions are locally different in the coated area on the substrate S onto which the ink is applied. This means that the drying speed of the ink droplets landed on the substrate S locally differs in the coated area. For instance, when the substrate S is relatively moved to the coater head 26c such that the ink is coated onto a given area on the substrate S, a solvent contained in the coated ink begins to sequentially volatilize from an area on which droplets of the ink is initially landed. Therefore, an atmosphere prevailing in a vicinity of the initially coated area has a solvent concentration that progressively increases as compared to those prevailing in other areas, whereby the coated ink is inhomogeneously dried and the surface shape of the solidified ink become irregular because of the local difference of the drying speed of the coated ink.

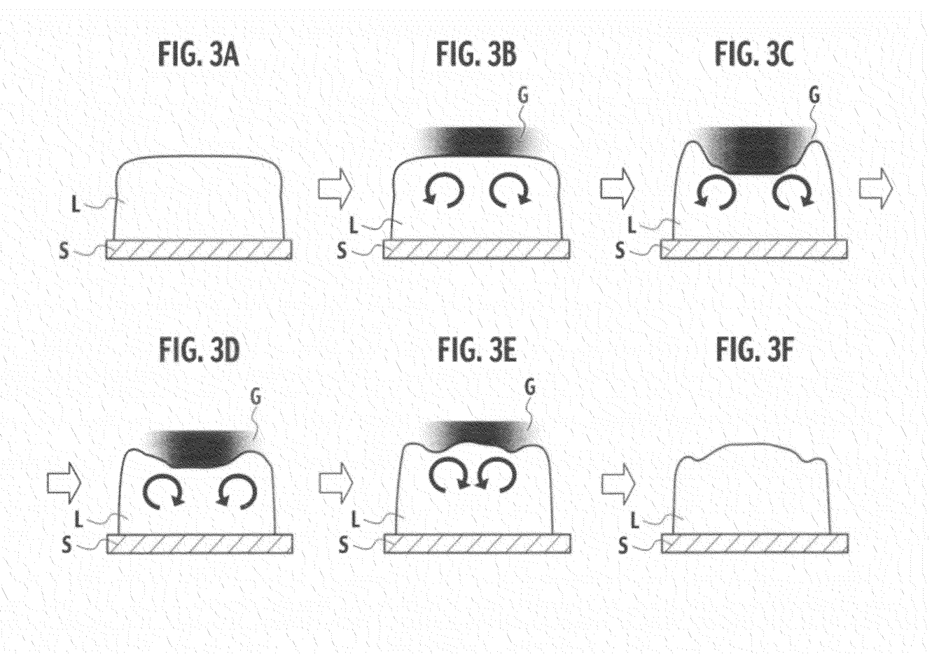

FIGS. 3A to 3F are typical views illustrating an evaporation mechanism of a liquid (ink) coated on the substrate S by using the ink jet coating apparatus 1. FIG. 3A shows the surface shape of a coated ink L at a time immediately after the ink L is applied onto the substrate S. For instance, when an organic EL ink is applied onto a glass substrate, the viscosity of the ink and the wetting property of the grass substrate is controlled to form a film with fine patterning.

When the coated ink L begins to dry on the substrate S as shown in FIG. 3B, a solvent contained in the coated ink L diffuses into a surrounding atmosphere to form a vapor layer G while convections arises inside the coated ink L as shown by arrows. Then, the edge areas of the coated ink L in the widthwise (i.e., left and right) direction of the figure have wider surfaces than that of the central area, and a solvent prevailing in an atmosphere close proximity to the edge areas has a concentration lower than that prevailing in the central area. Accordingly, the drying of the coated ink L proceeds from the edge areas to the center area. In other words, the evaporating speed of the coated ink L of the edge areas is faster than that of the central area. As a result, as shown in FIG. 3C, the surface tension of the edge areas becomes strong with an action by which the coated ink L of the edge areas is pulled upward. This causes the global surface shape of the coated ink L to become a concave shape with both edges raised upward. In cases where the solvent contained in the coated ink L has a high volatilization rate and the drying speed of the coated ink L is too fast, the drying of the coated ink L is finished with such a shape.

Also, in a case where the coated ink L has an appropriate drying speed, the drying of the coated ink L further proceeds from the state shown in FIG. 3C to a state shown in FIG. 3D. In this case, since the evaporation of the coated ink L is performed in the central area and the resulting surface tension of the central area increases, the total surface shape of the coated ink L begin to return to the original shape. Subsequently, after the drying of the coated ink L is finished on the edge areas, as shown in FIG. 3E the evaporation of the ink L continues on only the central area with an action by which the coated ink L is pulled in a central direction. As a result, the height of the central area becomes the same as these of the edge areas as shown in FIG. 3F.

Like this, the surface shape of the dried ink depends on the drying speed of the ink coated on the substrate S. Thus if the local difference of the drying speed of the coated ink appears in the coated area, the coated ink is inhomogeneously dried and the resulting surface shape of the dried ink become irregular.

Therefore the presently filed embodiment contemplates to provide a structure that includes the ink coater box 11 serving as an atmosphere holder that allows an atmosphere in a vicinity of a coated area of the substrate S onto which an ink is applied to be kept in an atmosphere that reduces volatilization of a solvent contained in the ink. In this structure, the substrate S retained on the top surface 21 of the base 2 is accommodated together with the coater under an airtight state. To regulate an atmosphere inside the ink coater box 11, a kind of gases to be introduced to the ink coater box 11 from the supply pipe 12 and the associated atmospheres such as a concentration, humidity, and flow rate are controlled. Further, the atmosphere in the vicinity of an area of the substrate S onto which the ink is coated is maintained under an atmosphere that reduces volatilization of the solvent until the coating of the ink onto a given area on the substrate S is finished, whereby the drying of the ink is prevented or remarkably delayed in the total coated area onto which the ink is applied. After the coating of the ink is finished, the ink is dried in the total coated area with the same condition by altering the above quantities inside the ink coater box 11. As a result, since the local difference of the drying speed of the coated ink is hard to appear on the substrate S, the presently filed embodiment enables to prevent the drying irregularity of the coated ink and the surface shape irregularity of the dried ink.

Then, to reduce volatilization of the solvent contained in the coated ink, the ink coater box 11 may be preferably maintained in an atmosphere where the solvent has a concentration within a range of 40% to 100% of the saturated one. In a case where the coated ink includes a water solution containing water as a solvent, it may be preferred that the solvent has a concentration within a range of 40% to 85% of the saturated one, that is, the atmosphere may preferably have a humidity within a range of 40% to 85%.

Under an atmosphere where the solvent has a concentration less than 40% of the saturated one, the drying speed of the coated liquid is too fast to be hard to obtain the solidified liquid with a favorable surface shape. Further, since the interior of a clean room in which coating step is carried out is commonly arranged to remain in an atmosphere with a humidity greater than 40%, it seems distant to control the humidity of the atmosphere to a value lower than that of the clean room in a case where the coated liquid is a water solution, or rather adverse affect occurs on the surface shape of the solidified liquid. On the contrary, to reduce volatilization of the solvent the solvent concentration of the atmosphere may be preferably maintained to a high value and the atmosphere may preferably lies in a state where the solvent has the concentration of 100%. In a case where the coated liquid includes a water solution, the humidity of 100% makes the atmosphere inside the coating apparatus reach a dew point with fears of the occurrences of short-circuiting of an electric circuitry and rust in the coating apparatus. Thus, the humidity of the atmosphere may be preferably maintained at the upper limit of 85%. To avoid such matters, a humidity of approximately 70% may be preferable in practice.

After the finish of ejecting droplets of a coating liquid to a given area on the substrate S, it is preferred for the coated liquid to homogeneously dry throughout the total coated area. To this end, the coating apparatus of the present invention may further comprises a structure that includes a homogeneous drying unit by which the coated area on the substrate S is homogeneously dried.

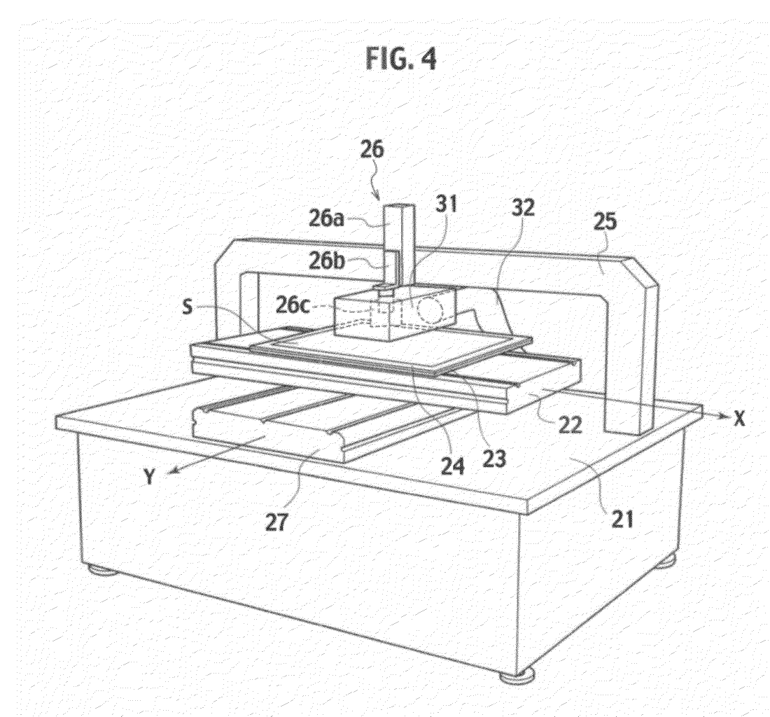

FIG. 4 is a perspective view showing the overall structure of a coating apparatus according to the second embodiment of the present invention. This coating apparatus of the presently filed embodiment features the provision of a homogeneous drying unit. Although the ink coater box 11 shown in FIG. 1 is not shown in FIG. 4 for convenience, the presently filed embodiment also incorporates the ink coater box 11 for permitting an atmosphere in a vicinity of a coated area on the substrate S to be kept under an atmosphere that reduces volatilization of a solvent until ejecting droplets of a coating liquid containing a solvent onto a given area on the substrate S is finished. Also, the same components as those shown in FIGS. 1 and 2 bear like reference numerals and therefore duplicated descriptions is herein omitted.

With the coating apparatus shown in FIG. 4, the coater head 26c of the coater head unit 26 and a suction hood 31 as a homogeneous drying unit that covers a vicinity of the substrate S placed on the stage 24 are provided in close proximity to the substrate S. The suction hood 31 has a box-shape with an opening facing the substrate S, and is supported by the arch-shaped support body 25 via a supporting unit (not shown). In the presently filed embodiment, an exhaust pipe 32 has one end connected to a side face portion of the suction hood 31 and the other end connected to an exhaust device (not shown) by which an atmospheric gas is exhausted from the inside of the suction hood 31.

Thus, since the suction hood 31 is able to locally exhaust by drawing an atmospheric gas from a position close proximity to a coated area of the substrate S onto which the coating liquid is applied, it becomes possible to homogeneously dry a coated area corresponding to an area covered with the suction hood 31. Also, mounting an air speedometer or airflow meter (not shown) in positions close proximity to the suction hood 31 enables the drying speed of the solvent to be regulated.

Since the coating apparatus of the presently filed embodiment adopts a drying method that locally exhausts by drawing an atmospheric gas, an area subjected to the effects of airflow is limited whereby no turbulence occurs in its surrounding airflow, as compared to a drying unit that injects airflow toward the surface of the substrate. This results in an advantage that only a local area to be dried can be homogeneously dried without causing any adverse affect on an area other than the local area.

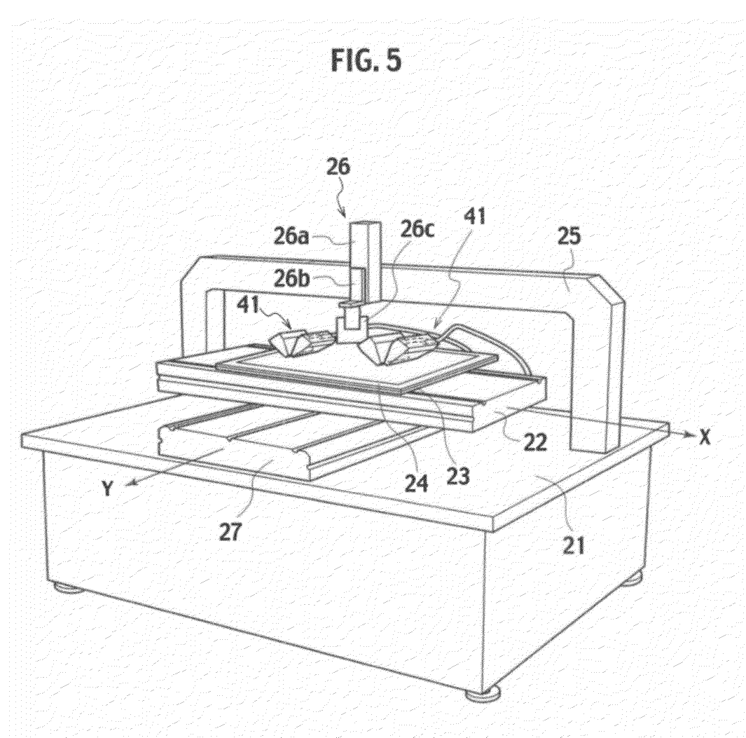

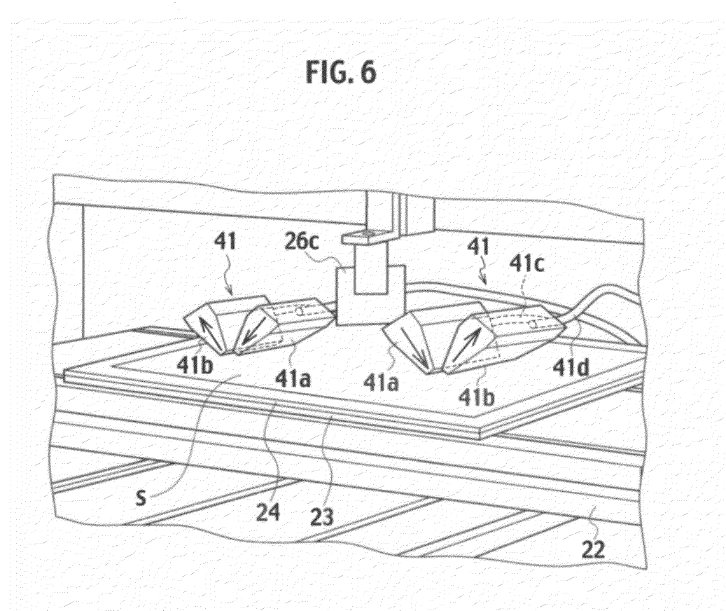

FIGS. 5 and 6 are perspective views showing the overall structure and an associated essential section of a coating apparatus according to the third embodiment of the present invention, respectively. The coating apparatus of the presently filed embodiment includes a homogeneous drying unit in the same manner as the second embodiment. Although the ink coater box 11 shown in FIG. 1 is not shown in FIGS. 5 and 6, the presently filed embodiment also incorporates the ink coater box 11 for permitting an atmosphere in a vicinity of a coated area on the substrate S to be kept under an atmosphere that reduces volatilization of a solvent until ejecting droplets of a coating liquid containing a solvent onto a given area on the substrate S is finished. Further, the same components as those of FIGS. 1 and 2 bear like reference numerals in FIGS. 5 and 6, and therefore duplicated descriptions are herein omitted.

The coating apparatus of the presently filed embodiment includes an air knife unit 41 serving as the homogeneous drying unit. The air knife unit 41 comprises an injection air knife nozzle 41a and a suction air knife nozzle 41b. Further the air knife unit 41 is supported with the arch-shaped support body 25 to be movable on a plane parallel to the substrate S by means of a support unit (not shown). Furthermore, a nozzle opening of the injection air knife nozzle 41a and a nozzle opening of the suction air knife nozzle 41b are placed in substantially close proximity to the substrate S in parallel with respect to one another. Connected to the injection air knife nozzle 41a is one end of a pipe 41c whose other end is connected to a blower (not shown). Connected to the injection air knife nozzle 41b is one end of a pipe 41d whose other end is connected to a pump (not shown). Since injecting a gas (e.g., air) from the nozzle opening of the injection air knife nozzle 41a while drawing the gas from the nozzle opening of the suction air knife nozzle 41b enables localized airflow to be generated in the vicinity of a coated area at a position between the injection air knife nozzle 41a and the suction air knife nozzle 41b, this makes it possible to allow the total coated area to be homogeneously dried. Moreover, in the presently filed embodiment, while the gas is locally injected from the injection air knife nozzle 41a, the injected gas is drawn for collection by the suction air knife nozzle 41b, whereby only a local area to be dried can be homogeneously dried without causing any adverse affect on an area other than the local area.

The homogeneous drying unit of the present invention is not limited to the particular structures of the second and third embodiments. For instance, it may be altered such that an atmosphere inside the ink coater box 11 of the coating apparatus 1 shown in FIG. 1 is sustained in an atmosphere that reduces volatilization of a solvent until the application of a coating liquid containing the solvent onto a given area of the substrate S is finished, whereby the gas is expelled from the ink coater box 11 through the exhaust pipe 13 to reduce pressure in the ink coater box 11. As a result, the coated liquid injected onto the substrate S can be homogeneously dried.

In addition, it can be realized such that when keeping an atmosphere close proximity to a coated area on a substrate S under an atmosphere that reduces volatilization of a solvent of a coating liquid containing the solvent until the application of the coating liquid onto a given area on the substrate S is finished, the atmosphere close proximity to the coated area on the substrate S is set to an atmosphere having a different kind of a solvent from the solvent contained in the coating liquid. In other words, the solvent contained in the coating liquid can be replaced with a different solvent until the coated liquid on the substrate S is dried. For instance, there is a case that a coating liquid containing one kind of a solvent is insufficient to satisfy both of the following solvent characters: a character needed for dissolving a solute; and a character concerning a drying speed needed after applying the coating liquid onto the substrate is finished. Thus, under cases where a coating liquid is required to have plural different characteristics to be present before and after coating process is performed, an attempt is undertaken to allow an atmosphere in a vicinity of a coated liquid to be sustained under an atmosphere saturated with a different solvent from a solvent contained in the coating liquid while the coating liquid applied onto the substrate S does remains a wet state. As a result, the solvent of the coating liquid coated on the substrate can be replaced by the different solvent under a state wherein the coated liquid is not dried by appearances to make it possible to satisfy the plural different characteristics. More particularly, such an attempt can be sufficed to be realized by supplying a gas, which includes a solvent different from a solvent contained in a coating liquid, to the ink coater box 11.

Examples employing the coating apparatus of the present invention are described hereunder.

(1) By using a coating liquid containing tetralin as a solvent adding a high polymer organic EL ink by 1%, the coating liquid was applied onto a substrate in a bank thereof by purging the ink jet coating apparatus 1 shown in FIG. 1 under nitrogen atmosphere while exhausting a gas (in a related art). Consecutively, the coated liquid was dried on a hot plate. As a result, even if coating conditions were varied, adjacent brightness unevenness on the substrate fell in a value within a range of 2% to 7%.

On the contrary, the coating liquid described above was similarly applied onto the substrate in the bank thereof under a state where nitrogen saturated with tetralin is supplied into the ink coater box 11 and then an atmosphere is sufficiently replaced. As a result, the drying of the coating liquid is reduced during coating process. After the coated liquid was dried on the hot plate, adjacent brightness unevenness was measured with a result wherein adjacent brightness unevenness fell in a value within a range of 0.5% to 2%.

(2) Next, by using a coating liquid containing water as a solvent adding PEDOT by 0.2%, a coating test was conducted in the same way described in the test (1). That is, in this test, water in place of tetralin was used as a solvent of the coating liquid. As a result, variation in thickness on the substrate surface fell in a value of approximately 30%, and in contrast, fell in a value less than 5% in a case where the ink coater box 11 was controlled in an atmosphere with humidity of 70% during coating process.

(3) By scanning the substrate S at a fixed speed with purging and drawing nitrogen for drying under a state where a pair of air knifes is placed to be proximate to each other as shown in FIG. 5 before the coated liquid was heated on the hot plate in the tests (1) and (2), the results of the tests (1) and (2) are further improved from 20% to 40%.

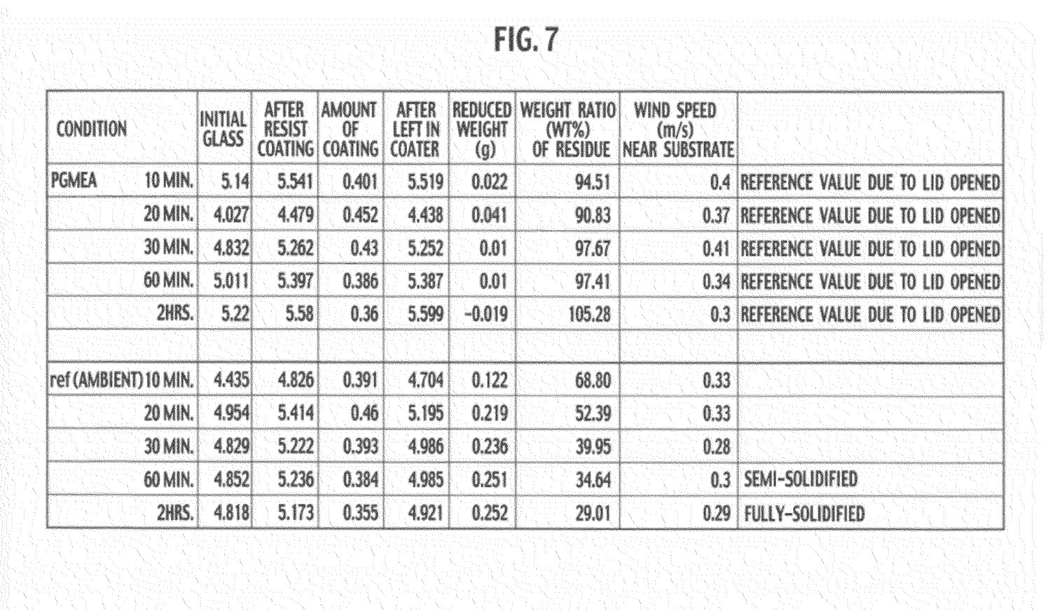

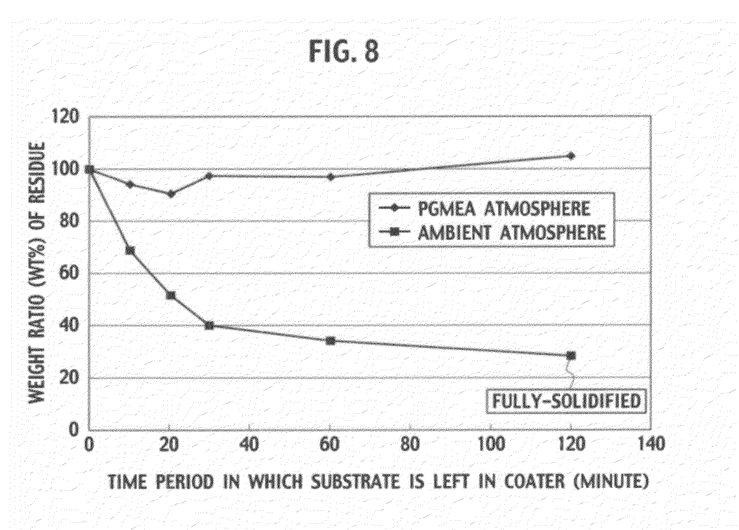

(4) Next, a test was conducted that an atmosphere close proximity to a coated area on the substrate S was replaced by an atmosphere with a different kind of a solvent from the solvent contained in the coating liquid. Here cyclohexane in which color resist is dissolved was used as the coating liquid. Then a glass substrate (with a size of approximately 5 cm in a square) onto which this coating liquid was applied was placed in a coating apparatus under an atmosphere in which PEGMEA was saturated. In the meantime, a comparative test was conducted that the substrate was placed in the coating apparatus with an atmospheric circumstance with a flow rate of 0.34 m/s. FIGS. 7 and 8 show a result that measured a change in weight of the substrate with a precision balance before and after keeping process that the substrate is left in the coating apparatus.

As is clear from FIGS. 7 and 8, even if an atmosphere was changed from an atmosphere with cyclohexane contained in the coating liquid to an atmosphere with a different solvent (PEGMIA), it could be confirmed that the drying of the coating liquid was reduced for a long time period.

From the results, it is clearly understood that by keeping the surface of the substrate under a solvent atmosphere when the coating liquid is applied, the drying of the coated liquid is delayed while the solidified liquid is homogeneously flattened to allow the solidified liquid to become prominent in shape-homogeneity.

Moreover, in case of using water as a solvent contained in the coating liquid, the presence of humidity with an atmospheric concentration higher than 85% leads to result in occurrence of dew formation with the resultant occurrence of rust and short-circuiting of an electric circuitry.

Basically, the foregoing results begin to appear at an atmospheric concentration greater than 40% and it is concluded that the maximum effect is obtained at 100%.

The entire content of Japanese Patent Application No. P2004-2049-27 with a filing data of Jul. 12, 2004 of which is expressly incorporated herein by reference in its entirety.

It is also to be noted that, besides those already mentioned above, many modifications and variations of the above embodiments may be made without departing from the novel and advantageous features of the invention. Accordingly, all such modifications and variations are intended to be included within the scope of the appended claims.

What is claimed is:

1. A coating method for applying a coating liquid including a solute and a solvent onto a given area on a substrate so as to allow the coating liquid to be solidified on the substrate by volatizing the solvent, the coating method comprising:
keeping an atmosphere in a vicinity of a coated area of the given area on the substrate under a nonvolatile atmosphere that restrains volatilization of the solvent until applying the coating liquid onto the given area of the substrate is finished, and
drying the coating liquid applied onto the given area on the substrate under a homogeneously drying condition after applying the coating liquid onto the given area on the substrate is finished.

2. The coating method according to claim 1, wherein the drying step further comprising:
locally generating airflow in a vicinity of a coated area of the given area on the substrate, thereby locally homogeneously drying the coating liquid applied on the coated area.

3. The coating method according to claim 1, wherein atmosphere in a vicinity of a coated area of the given area on the substrate onto which the coating liquid is applied is maintained under an atmosphere containing a different solvent from the solvent contained in the coating liquid so as to replace the solvent contained in the coating liquid with the different solvent until the coating liquid applied onto the given area on the substrate is dried.

4. The coating method according to claim 1, wherein the atmosphere in the vicinity of a coated area of the given area on the substrate onto which the coating liquid is applied is maintained under an atmosphere where the solvent has a concentration within a range of 40% to 100% of a saturated concentration.

5. The coating method according to claim 1, wherein under a situation where the coating liquid includes a solution containing water, the atmosphere in the vicinity of a coated area of the given area on the substrate onto which the coating liquid is applied is maintained under an atmosphere where a humidity lies within a range of 40% to 85%.

6. The coating method according to claim 3, wherein the solvent contained in the coating liquid includes cyclohexane, and the different solvent includes PEGMIA.
